(19) United States
(12) Patent Application Publication
(10) Pub. No.: US 2025/0110256 A1
(43) Pub. Date: Apr. 3, 2025

(54) METHOD, DEVICE AND ELECTRICAL DEVICE OF DESIGNING METALENS AND STORAGE MEDIUM

(71) Applicant: SHENZHEN METALENX TECHNOLOGY CO.,LTD, Shenzhen (CN)

(72) Inventors: Chenglong HAO, Shenzhen (CN); Fengze TAN, Shenzhen (CN); Jian ZHU, Shenzhen (CN)

(73) Assignee: SHENZHEN METALENX TECHNOLOGY CO.,LTD, Shenzhen (CN)

(21) Appl. No.: 18/884,076

(22) Filed: Sep. 12, 2024

(30) Foreign Application Priority Data
Sep. 28, 2023 (CN) 202311281382.5

(51) Int. Cl. G02B 1/00; G02B 27/00

(52) U.S. Cl. CPC G02B 1/002; G02B 27/0012

(57) ABSTRACT

A metalens is provided, the metalens includes: a substrate, a plurality of structural units arranged in periodicity; and the structural units are perpendicular to the substrate; the metalens includes a plurality of phase-modulation regions, and each phase-modulation region includes the plurality of structural units; where, each structural unit includes m phase-modulation layers, m≥2, so as to make each structural unit in each phase-modulation region provide any phase within the interval of [0,2π] and each phase-modulation region cover the phases within the interval of [0,2π] at a working waveband.

### CROSS-REFERENCE TO RELATED APPLICATION

This application claims the benefit of priority from Chinese Patent Application No. 202311281382.5, filed on Sep. 28, 2023. The content of the aforementioned application, including any intervening amendments thereto, is incorporated herein by reference in its entirety.

### TECHNICAL FIELD

The present application relates to the field of a metalens, in particular to a method, a device for designing a metalens.

### BACKGROUND

Metalens is an application of the metasurface, and the metasurface is a sub-wavelength artificial nanostructured film, which can modulate the amplitude, phase, and polarization of the incident lights by the nanostructures.

Usually, the closer to the edge of the metalens, the larger the phase gradient of the metalens required and the more difficult to achieve phase covering phases of [0,2π]. However, because the same nanostructures on the metalens have different phases response to different wavelengths, large chromatic aberrations will be produced for broadband imaging. The larger the bandwidth is, the more difficult it is to achieve the phases covering of [0,2π]. Thus, the aperture of the metalens is inversely proportional to the bandwidth of the working waveband.

With the increasing requirements for broadband imaging, it is urgent to overcome the aperture limit of bandwidth of metalenses.

### SUMMARY

In order to solve the technical problem that the aperture of the metalens has limitation of bandwidth of the incident lights. The present application embodiment provides a method, a device, an electrical device for designing a metalens and a storage medium.

Optionally, a metalens is provided, where the metalens includes a substrate, a plurality of structural units arranged in periodicity; and the structural units are perpendicular to the substrate;
the metalens includes a plurality of phase-modulation regions, and each phase-modulation region comprises the plurality of structural units;
where, each structural unit includes m phase-modulation layers, m≥2, so as to make each structural unit in each phase-modulation region provide any phase within the interval of [0,21] and each phase-modulation region cover the phases within the interval of [0,21] at a working waveband.

Optionally, the metalens includes:
each phase-modulation layer in the m phase-modulation layers includes a nanostructure and a filler material;
the filler material is set around the plurality of nanostructures, and the height of the filler material is greater than or equal to the height of the plurality of nanostructures;
where all the phase-modulation layer of the structural units at the same level forms a plate structure, and the plate structure is parallel to the substrate.

Optionally, the phase-modulation layers comprise a first phase-modulation layer to an mₜₕ phase-modulation layer;
the first phase-modulation layer to the mₜₕ phase-modulation layer are stacked in the order from the substrate to the side away from the substrate;
the refractive index n of the filler material in the second phase-modulation layer to the mₜₕ phase-modulation layer satisfies: n≠1.

Optionally, m=2.

Optionally, m=3.

Optionally, the metalens satisfies:

$$1 \leq \frac{{h}_{1}}{{h}_{2}} \leq 1.3 ;$$

where h₁ is the height of the filler material, and h₂ is the height of the plurality of nanostructures.

Optionally, the metalens satisfies:

$$1 \leq \frac{{h}_{1}}{{h}_{2}} \leq 1.3 ,$$

where h₁ is the height of the filler material, and h₂ is the height of the plurality of nanostructures.

Optionally, the metalens satisfies:

$$1 \leq \frac{{h}_{1}}{{h}_{2}} \leq 1.1 ;$$

where h₁ is the height of the filler material, and h₂ is the height of the plurality of nanostructures.

Optionally, the metalens satisfies:

$$1 \leq \frac{{h}_{1}}{{h}_{2}} \leq 1.1 ;$$

where h₁ is the height of the filler material, and h₂ is the height of the plurality of nanostructures.

Optionally, the metalens further comprises: a disconnected layer, and the disconnected layer is set between the adjacent phase-modulation layers.

Optionally, the material of the disconnected layer is different from the material of the adjacent phase-modulation layer under the disconnected layer.

Optionally, the shape of the phase-modulation region is a combination of at least two shapes of circle, square, rectangle, cross, glyph.

Optionally, in the second aspect, a method of designing a metalens is provided, the method is applied to the metalens, where the method includes:
selecting a first number of structural units randomly, and the first number is greater than or equal to 2;
determining a phase response of the first number of structural units by taking at least one characteristic parameter of one nanostructure or the plurality of nanostructures of the first number of each structural unit as a variable; and the phase response is a function of an incident light and the at least one characteristic parameter;
obtaining a target structural unit by performing an interpolation search according to the function.

Optionally, the “performing an interpolation search according to the function” includes:
determining a second number of the structural units, so as to realize the phase of the metalens covering the phases from 0 to 2π;
performing a multi-wavelength sampling on each nanostructure of the second number of the structural units and selecting a combination of characteristic parameters corresponding to the minimum absolute value of the sum of phase variations between the phase responses and the target phases at the sampling wavelengths;
constructing the second number of target structural units based on the characteristic parameters corresponding to the minimum absolute value of the sum of phase variations between the phase responses and the target phases at the sampling wavelengths.

Optionally, the phase of the target structural units satisfies:

$$min ( {\sum }_{1}^{M} \vert ( φ 1 ( {r}_{i 1 j} , {r}_{i 2 j} , {r}_{i 3 j} , {λ}_{i} ) - \frac{j * 2 π}{N} ) \vert ) ;$$

where M is a number of the sampling wavelengths in the multi-wavelength sampling; N is a number of the target structural units; φ1(rᵢ₁ⱼ, rᵢ₂ⱼ, λᵢ₃ⱼ, λᵢ) is a normalized phase of the jₜₕ structural unit at the iₜₕ wavelength; and j is a positive integer which is less than or equal to N-1.

Optionally, the characteristic parameter includes one or more of a shape, radius, height, aspect ratio and refractive index of the nanostructure.

Optionally, the multi-wavelength sampling includes:
selecting a plurality of discrete wavelengths in a working waveband of the metalens; at each wavelength of the plurality of discrete wavelengths,

determining the phase response by taking a radius of one nanostructure or the plurality of nanostructures;
selecting the radius of the nanostructure that corresponding to the minimum absolute value of the sum of phase variations between the phase responses and the target phases at the plurality of discrete wavelengths.

In the third aspect, a device of designing a metalens is provided, the device is applied to implement the method, where the device includes:
an inputting module, the inputting module is configured to input a number of structural units, a number of phase-modulation layers and characteristics parameters of each nanostructure in each structural unit;
a simulation module, the simulation module is configured to calculate a plurality of phase responses; and the phase responses is a function of the incident light and at least one characteristic parameter;
a search module, the search module is configured to perform an interpolation search according to the function.

In the fourth aspect, an electronic device, includes: a bus, a transceiver, a memory, a processor and a computer program;
where the computer program is stored in the memory and executable on the processor; the transceiver, the memory and the processor are connected through the bus; the computer program is executed by the processor, so as to implement the method.

In the fifth aspect, a non-transitory computer-readable storage medium in which a computer program is stored, where the computer program is executed by a processor, so as to implement the method.

In the first aspect, a metalens is provided by the present application, the metalens includes:
The above technical scheme provided by the embodiment of the present application achieves at least the following technical effects:
The metalens provided by the application makes each structural unit have larger degrees of phase-modulation freedom by setting m phase-modulation layers on each structural unit, so as to realize that each phase-modulation region could cover phases of [0, 2π]. Then, the whole metalens could cover the phases of [0, 2π]. Therefore, the bandwidth limitation of the working waveband to the aperture of the metalens is overcome, and the larger aperture of the broadband imaging is realized.

The method of designing a metalens provided by the application determines the phase response of each phase-modulation layer in the first number of phase-modulation layers through taking at least one characteristic parameter of the nanostructures in the first number structural units in the first phase-modulation layer; the phase response is a function between the incident wavelength and at least one characteristic parameter; and an interpolation search is performed based on the function, so that the target structural unit is obtained. And the target structural unit has the same phase response to different wavelengths in the broadband. In this way, the broadband limitation to the aperture of metalens is broken, and large aperture and broadband imaging of metalens is realized.

### BRIEF DESCRIPTION OF THE DRAWINGS

The present application may be better understood by reference to the description given below in combination with the drawings, where the same or similar drawing markings are used in all the drawings to represent the same or similar assemblies. The drawings are included in the specification along with the following detailed description and form part of the specification, and to further illustrate the preferred embodiments of the application and explain the principles and advantages of the application.

FIG. 1 shows a schematic diagram of an optional phase-modulation region of the metalens provided by the embodiment of the present application.

FIG. 2 shows a structural schematic diagram of an optional metalens provided by the embodiment of the present application, and the metalens includes 2 phase-modulation layers.

FIG. 3 shows a schematic diagram of an optional metalens provided by the embodiment of the present application, and the metalens includes 3 phase-modulation layers.

FIG. 4 shows a schematic diagram of an optional metalens provided by the embodiment of the present application, and the metalens includes 4 phase-modulation layers.

FIG. 5 shows a schematic diagram of an optional metalens provided by the embodiment of the present application, and the height of the filler material in the first phase-modulation layer and the second phase-modulation layer is equal to the height of the nanostructures.

FIG. 6 shows a schematic diagram of an optional metalens, and the refractive index of the filler material of the phase-modulation layer is not equal to 1.

FIG. 7 shows a schematic diagram of optional metalens provided by the embodiment of the present application.

FIG. 8 shows an optional flow chart of the method of designing a metalens provided by the embodiment of the present application.

FIG. 9 shows a phase response of the target structural unit obtained by the method of designing a metalens provided by the embodiment of the present application.

FIG. 10 shows another phase response of the target structural unit obtained by the method of designing a metalens provided by the embodiment of the present application.

FIG. 11 shows a schematic diagram of the design device of the metalens provided by the embodiment of the present application.

FIG. 12 shows a schematic diagram of the electronic device provided by the embodiment of the present application.

### DETAILED DESCRIPTION OF DISCLOSURED EMBODIMENTS

The present application is described more comprehensively with reference to the drawings, and embodiments are shown in the drawings. However, the present application may be implemented in many different ways, and should not be interpreted as limited to the embodiment described herein. Instead, these embodiments are provided such that the application will be exhaustive and complete, and will fully convey the scope of the application to those skilled in the art. The same attached drawing marks throughout indicate the same components. Furthermore, in the drawings, the thickness, ratio and size of the components are enlarged to clearly illustrate.

Furthermore, the described features, structures or features may be combined in one or more exemplary embodiments in any suitable manner. In the following description, many specific details are provided to give a full understanding of the exemplary embodiments of this application. However, those skilled in the art will be aware that one or more of the specific details may be omitted from the proposed technical solution, or other modules, groups, etc. may be adopted. In other cases, the aspects of the present application are blurred without detailed showing or describing the public structure, method, implementation or operation to avoid over-dominance.

Embodiments according to the present application will be described below with reference to the accompanying drawings.

Since the aperture of the metalens is inversely proportional to the bandwidth of the working waveband, there are some technical problems in designing the metalens for broadband imaging, when the aperture of the metalens is larger, the numerical aperture is higher and the bandwidth is larger. Thus a larger database is needed to realize covering the phases of [0,2π]. However, with the limitation of aspect ratio in the existing process and the characteristic size of the nanostructures, the coverage of the phase provided by nanostructures is limited. To satisfy the larger aperture and the broadband imaging for the metalens, the method of designing the metalens in the prior art divides the metalens with larger aperture into regions, and each region of the metalens only modulates the incident lights with a specific wavelength. Although this method could satisfy a larger aperture and broadband imaging at the same time, each region only transmits single-wavelength light, which seriously damages the transmitted light energy and sacrifices the light energy utilization of the metalens.

A metalens is provided by the present application, and the metalens provided by the application makes each structural unit have larger degrees of phase-modulation freedom by setting m phase-modulation layers on each structural unit, so as to realize that each phase-modulation region could cover phases of [0, 2π]. Then, the whole metalens could cover the phases of [0, 2π]. Therefore, the bandwidth limitation at the working waveband to the aperture of the metalens is overcame, and the larger aperture and the broadband imaging of the metalens are realized.

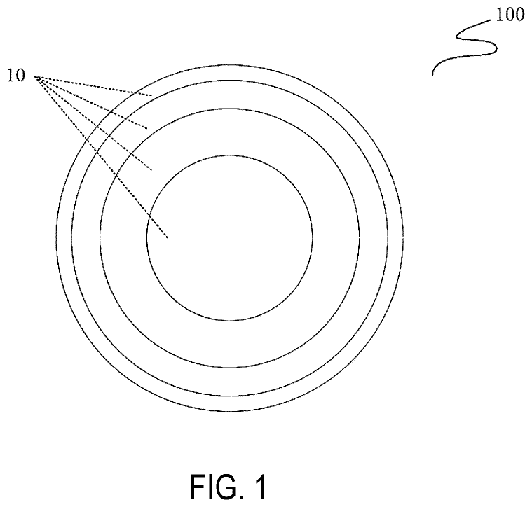

The phase-modulation region refers to any region on the metalens which needs to cover phases of [0, 2π], and all the phase-modulation regions constitute the metalens. In one optional embodiment, when the phase distribution of the metalens is the collimation phase, the phase of the metalens satisfies

$$φ ( x , y ) = \frac{2 π}{λ} ( f - \sqrt{{f}^{2} + {x}^{2} + {y}^{2} )} ;$$

where r is the distance between the metalens center and the nanostructure center; λ is the wavelength of the metalens; (x, y) is the coordinate of the surface of the metalens; f is the focal length of one metalens. FIG. 1 shows a metalens containing a plurality of phase-modulation regions of a circular region centered at the center of the metalens and a circular region surrounding the circular region. When the phase distribution of the metalens is other phase distributions except for the collimation phase, the phase-modulation region constituting the metalens is not limited to the circle and ring, and may be a combination of at least two shapes in any other shapes, such as a square, rectangle, cross, glyph.

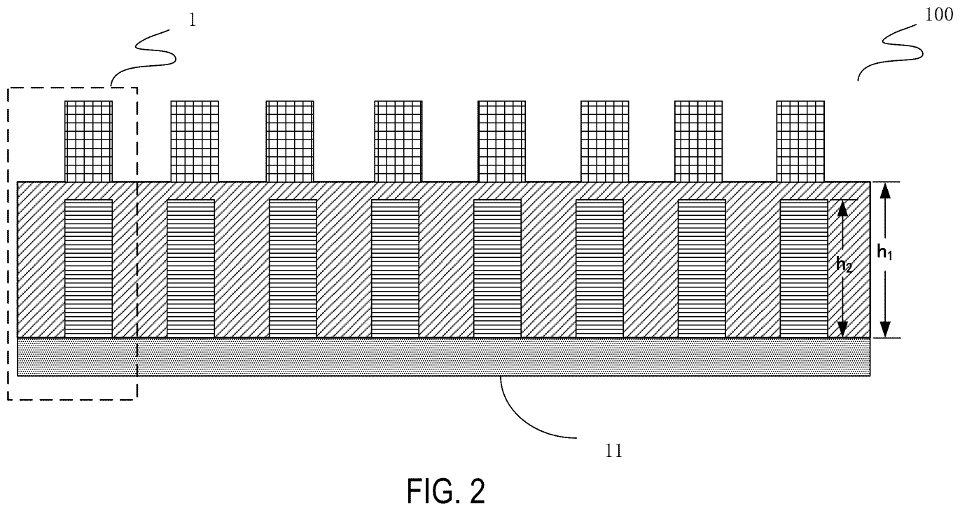

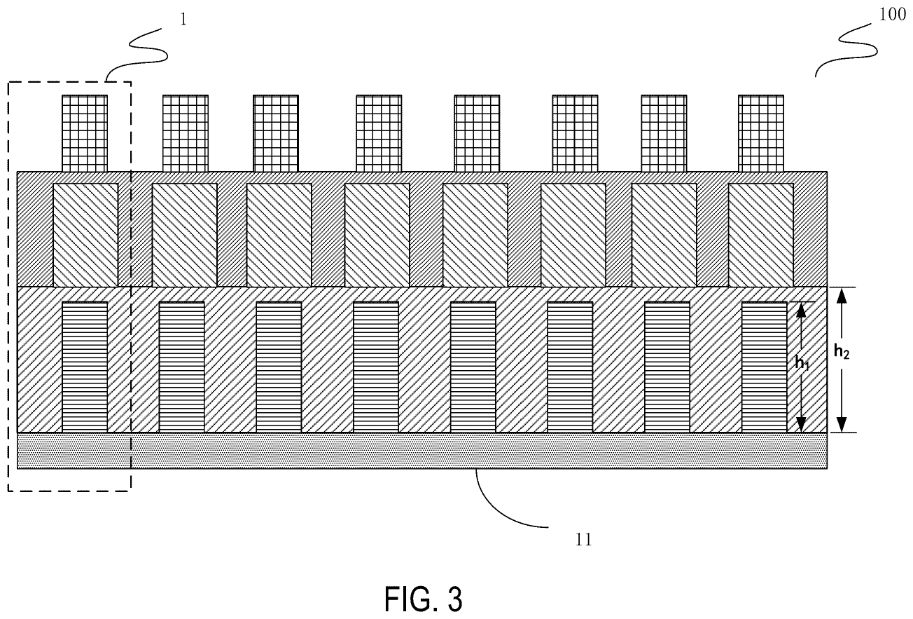

FIG. 2 shows a structural schematic diagram of optional metalens provided by the embodiment of the present application. In FIG. 2, the metalens 100 includes a substrate, a plurality of structural units arranged in periodicity; and the structural units are perpendicular to the substrate; the metalens comprises a plurality of phase-modulation regions, and each phase-modulation region includes the plurality of structural units; where, each structural unit includes m phase-modulation layers, m≥2. FIG. 2 shows the situation when m is equal to 3, namely each structural unit includes 3 phase-modulation layers; FIG. 3 shows the situation when m is equal to 4, namely each structural unit includes 4 phase-modulation layers. The number of phase-modulation layers 12 in the same structural unit 1 is positively correlated with the phase-modulation freedom of the metalens. In other words, the use of a larger number of phase-modulation layers 12 in conjunction with one another can greatly increase the phase-modulation freedom of the metalens, thus realizing the phases covering the working waveband of [0,2π]. Optionally, the working wavebands of the metalens include one or more of the visible light, near-infrared, and far-infrared wavebands.

In an optional embodiment of the present application, each phase-modulation layer of the m phase-modulation layers 12 includes a nanostructure 121 and a filler material 122 set around the plurality of nanostructures 121. The arrangement of filler material facilitates the processing of the nanostructure 121 located at its upper phase-modulation layer 12. In addition, the cooperation between the filler material 122 and the plurality of nanostructures 121 is able to increase the accuracy of phase modulation. The filler material may be air and other transparent material at the working waveband. For example, when the working waveband of the metalens is a visible waveband, the filler material 122 is a transparent material at the visible waveband; when the working waveband of the metalens is a near-infrared waveband, the filler material 122 is a transparent material at the near-infrared waveband; when the working waveband of the metalens is a far-infrared waveband, the filler material 122 is a transparent material at the far-infrared waveband. Optionally, the extinction coefficient of the filler material is less than 10-2. In one structural unit 1, the filler materials of each phase-modulation 122 may be the same, or only partially the filler materials 122 in the phase-modulation layer 12 may be the same; or the filler materials of each phase-modulation 122 may be different. When the working waveband is a visible waveband, the filler material may be a photoresist, quartz glass, silicon nitride, titanium oxide, alumina (sapphire), crystalline silicon (including crystalline and amorphous silicon), gallium nitride, crystalline germanium, selenium sulfide, selenium sulfide, selenium sulfide, sulfur glass or other materials.

Further, m phase-modulation layers 12 include a first phase-modulation layer to an mₜₕ phase-modulation layer; the first phase-modulation layer to the mₜₕ phase-modulation layer are stacked in the order from the substrate to the side away from the substrate; the refractive index n of the filler material in the second phase-modulation layer to the mₜₕ phase-modulation layer satisfies: n≠1. The structural unit 1 including three phase-modulation layers is taken to be an example, as shown in FIG. 3, the filler materials 122 of the second phase-modulation layer located at the middle layer and the third phase-modulation layer located at the bottom are both transparent materials at the working waveband except for air, and the refractive index n of the filler materials satisfy: n≠1. Furthermore, the type of the filler material 122 of the second phase-modulation layer located at the middle layer and the filler material 122 of the third phase-modulation layer located at the bottom are shown as different figure grains. The visible waveband of the working waveband of the metalens is taken as an example, the filler material in the second phase-modulation layer may be the transparent silicon nitride in the visible waveband, and the filler material in the third phase-modulation layer may be the transparent silica in the visible waveband. In an optional embodiment, the filler material of the second phase-modulation layer located at the middle layer and the filler material of the third phase-modulation layer located at the bottom layer may be the same, for example, are silicon nitride.

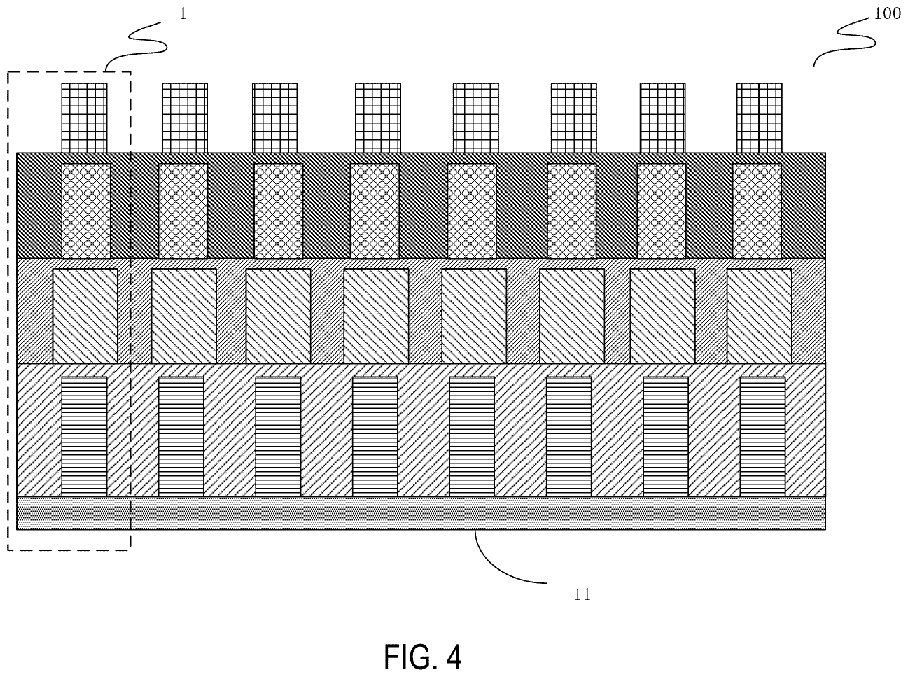

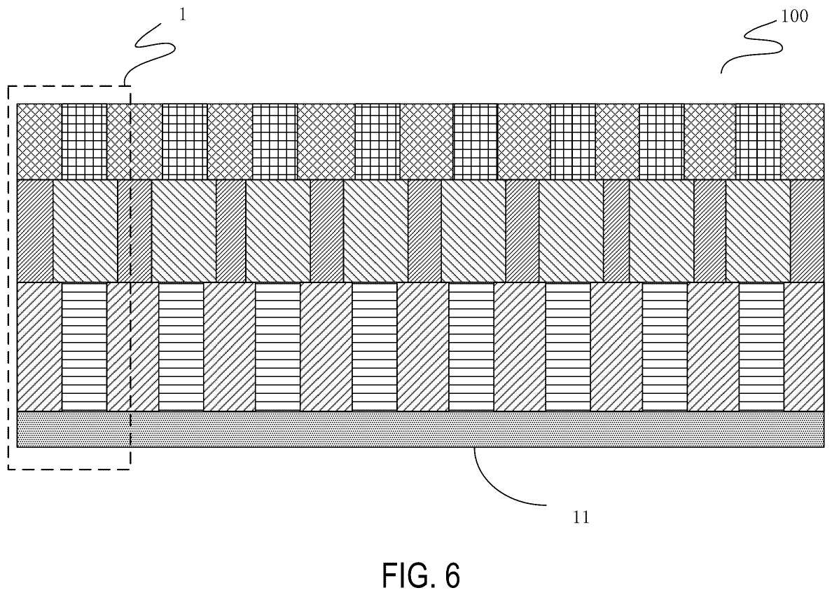

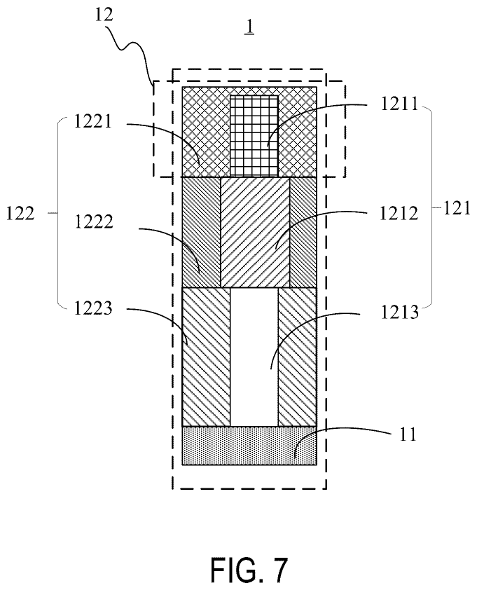

In an optional embodiment of the present application, the filler material in the first phase-modulation layer located at the topped layer (namely the farthest layer from the substrate) may be air, as shown in FIG. 2 to FIG. 5, or may be other transparent materials at the working waveband (its refractive index n≠1), as shown in FIG. 6 and FIG. 7.

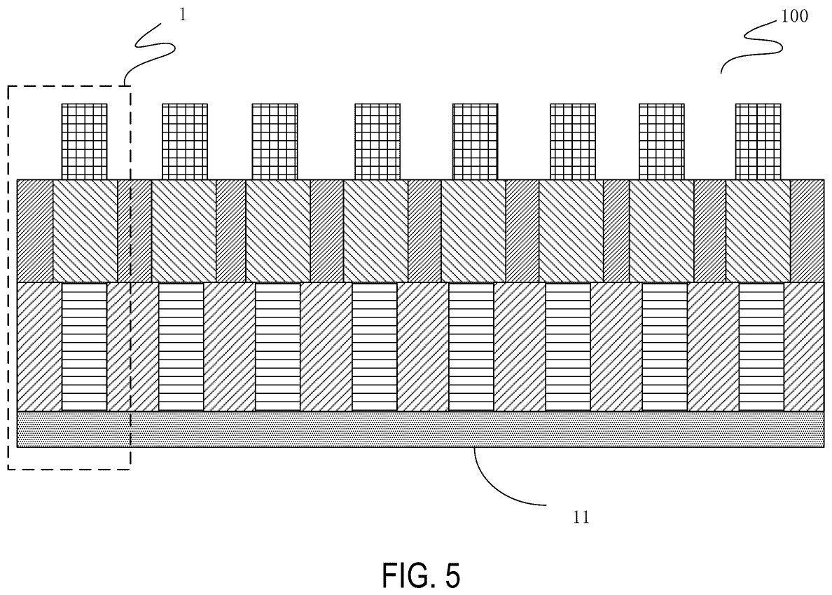

In one optional embodiment, the height of the filler material 122 is greater than or equal to the height of the nanostructures121. FIG. 2 to FIG. 4 show the situation that the height of the filler material 122 is greater than the height of the nanostructures121. FIG. 5 to FIG. 6 show the situation that the filler material 122 in the phase-modulation layer 12.

Further, the height of the filler material 122 h₁ and the height of the nanostructures 121 h₂ satisfy:

$$1 \leq \frac{{h}_{1}}{{h}_{2}} \leq 1.3 .$$

In the present application, the design of the interval of h₁/h₂ is used to meet the requirements of processing capability and the phase-modulation accuracy at the same time.

In addition, all the phase-modulation layers of the structural units at the same level forms a plate structure, and the plate structure is parallel to the substrate. Namely, for the modulation-phase layers at the same level, the heights of the filler material 122 h₁ at one level are the same, and the heights of the nanostructures 121 h₂ at one level are the same.

Specifically, in order to ensure the feasibility of the processing and avoid the filler material at the topped layer falling into the phase-modulation layer located at the bottom level, thus resulting the deviation from the original design intention, the lowest value of h₁/h₂ is configured to be 1. Moreover, in order to make sure that the filler material and the nanostructures can co-operate better to make the phase modulation more precise at their phase-modulation layer while protecting the nanostructures, the highest value of the h₁/h₂ is configured to be 1.3. Preferably, in one embodiment

$$1 \leq \frac{{h}_{1}}{{h}_{2}} \leq 1.1 .$$

In some optional embodiment, there is a disconnected layer between the adjacent phase-modulation layers; optionally, the material of the disconnected layer is different from the material of the adjacent phase-modulation layer under the disconnected layer.

The applicants of the present application found that if the nanostructure of the metalens can have the same phase response range for different wavelengths, the bandwidth limitation of the metalens for the incident light can be overome. Based on this, this application provides a method of designing a metalens.

The method provided by the present application is applied to the metalens shown in FIG. 2 to FIG. 6. The method includes:
Selecting a first number of structural units randomly, and the first number is greater than or equal to 2; the first number is greater than or equal to 2.

Determining a phase response of the first number of structural units by taking at least one characteristic parameter of one nanostructure or the plurality of nanostructures of the first number of each structural unit as a variable; and the phase response is a function of an incident light and the at least one characteristic parameter.

Obtaining a target structural unit by performing an interpolation search according to the function.

Specifically, the different structural units in the first number of structural units have different structural parameters. The structural parameters include the number of layers of the phase-modulation layer and the characteristic size of the nanostructure. The first number of structural units constitutes the database of initial structural units.

Furthermore, each structural unit includes a plurality of phase-modulation layers, and each phase-modulation layer includes a nanostructure. It should understood that each nanostructure has various kinds of characteristic parameters. For example, the characteristic parameters include one or more of a shape, radius, height, aspect ratio and refractive index of the nanostructure. The phase response of the structural unit can be changed by adjusting at least one characteristic parameter of any one or more nanostructures. According to the embodiment of the present application, the characteristic parameters of the nanostructures in any two phase-modulation layers in the structural unit may be all different or at least partially the same.

According to the embodiment of the present application, the phase response of the first number of structural units is determined as a variable by at least one characteristic parameter of any one or more of the nanostructures of each of the first number of structural units. The radius of the nanostructure is taken as an example, assuming that the structural unit includes the m phase modulation layers, then the characteristic parameter of the nanostructures in the structural unit is the set of radii of all the nanostructures, for example, {r₁, r₂, . . . , rₘ}.

In an optional embodiment of the present application, the structural unit includes three phase modulation layers, and the method includes: according to the target waveband, taking one characteristic parameter (e.g. the radius of the nanostructure) as a variable and keeping other characteristic parameters (the shape, height, refractive index of the nanostructure) constant, and scanning the structural units to obtain the optional phase response of the structural unit. The phase response is a function of radius of the nanostructures and the wavelength of the incident lights, which may be φ(r₁, r₂, r₃, λ). It should be understood that scanning the structural units is a simulation of phase response for the specific structural units by the computer, for example, by method of FDTD (Finite Difference Time Domain).

According to the embodiment by the present application, the metalens applied to the visible waveband is taken as an example. For example, the shape of the nanostructures is selected to be cylinder with a periodicity of 220 nm, the range of the diameter of the cylinder is from 50 to 170 nm. The diameter of the cylinder of is taken to be a characteristic parameter, and each 10 nm is a sampling interval of the characteristic parameters. One structural unit is scanned every 10 nm in the visible waveband, each layer has (170-50)/10+1=13 structural units to be scanned; if each 3 nm is a sampling interval of the characteristic parameters, one structural unit is scanned every 10 nm in the visible waveband, each layer has (700-400)/30+1=11 structural units to be scanned, and establishing the initial structural unit database requires a total of 13*13*13*11 phase responses of the structural units. Therefore, the obtained phase φ(r₁, r₂, r₃, λ) is a four-dimensional array, and the scanning time is 7 hours. The selected sampling interval is larger, and the data need to be scanned is less. However, after the interpolation, the accuracy will decrease to a certain extent. The smaller the sampling interval is, the larger the data, and the longer the scanning time spent, but higher the accuracy. If the elaborate characteristic parameter scanning interval or the wavelength scanning interval are used at the beginning, the scanning time will be significantly increased. More specifically, the characteristic parameters are scanned, for example, keeping the radius of the nanostructures of the first and second phase-modulation layers unchanged, and only scanning the phases of 13 nanostructures at 10 nm scanning intervals in the third phase-modulation layer to obtain 13 phases; next, the radius of the first phase-modulation layer is kept unchanged, and the radius of each of the 13 corresponding nanostructures in the second phase-modulation layer is added to 10 nm to be 13 new phases; Adding a further 10 nm to the newly acquired nanostructures another 13 new phases; and so on, until the minimum radius of the 13 nanostructures in the second phase-modulation layer has changed from 50 nm to 170 nm. Finally, while the nanostructures of the third and second phase-modulation layers keep unchanged, the nanostructures of the first phase-modulation layer are scanned at 10 nm intervals, gradually stacking the radius of the nanostructures from 50 nm to 170 nm, and finally obtaining 13*13*13*11 phases.

Further more, after scanning the phase responses of the structural units with at least one characteristic parameter as a variable, an interpolation search based on the phase response is performed to obtain an more elaborate structural unit. Preferably, a characteristic parameter as a variable is scanned for a function of the characteristic parameter and the incident wavelength, and then an interpolation search is performed based on the function to obtain the structural units. Compared with the optimal solution of the phase of the structural unit obtained by scanning all the characteristic parameters, the method provided by the present application includes firstly scanning partial characteristic parameters, next performing the interpolation search to obtain more elaborate structural units while saving computing power and increasing search efficiency.

In some optional embodiments, performing an interpolation search according to the function includes:
Determining a second number of the structural units, so as to realize the phase of the metalens covering the phases from 0 to 2π; optionally, the second number is less than the first number.

Performing a multi-wavelength sampling on each nanostructure of the second number of the structural units and selecting a combination of characteristic parameters corresponding to the minimum absolute value of the sum of phase variations between the phase responses and the target phases at the sampling wavelengths.

Constructing the second number of target structural units based on the characteristic parameters corresponding to the minimum absolute value of the sum of phase variations between the phase responses and the target phases at the sampling wavelengths.

In one embodiment, the structural unit with 3 phase-modulation layers is take as an example, and the radius of the nanostructure is taken as a variable to perform a sampling, the method includes:
Determining the second number is N.

The phase response is φ(rᵢ₁, rᵢ₂, rᵢ₃, λᵢ) after interpolation, selecting any M wavelengths of the working waveband as sampling points to scan; i is any integer between 1 and M.

The minimum absolute value of the sum of phase variations between the phase responses and the target phases at the sampling wavelengths min(Σ₁^{M} φ(rᵢ₁ₙ, rᵢ₂ₙ, rᵢ₃ₙ, λᵢ)) is taken as the target to perform a search, so as to obtain N sets including the radius of the nanostructures searched; where

$$φ ( {r}_{i 1 n} , {r}_{i 2 n} , {r}_{i 3 n} , {λ}_{i} ) = φ ( {r}_{i 1} , {r}_{i 2} , {r}_{i 3} , {λ}_{i} ) - \frac{n 2 π}{N} , n = 1 , 2 , … , N .$$

Constructing N target structural units according to the sets including the radius of the nanostructures.

It should be noted that N represents that the discretization phases covering from 0 to 2π is N orders. For example, N may be 8, 16, 32, 64, or other integers. Preferably, N may be greater than or equal to 6. Preferably, a larger value of N is the better. For example, the discrete phases of 2π are N target phases, and are

$$\frac{2 π}{N} , \frac{2 * 2 π}{N} , \frac{3 * 2 π}{N} , \frac{4 * 2 π}{N} , … , \frac{( N - 1 ) 2 π}{N} ,$$

respectively. Assuming that the target phase of any structural unit after the interpolation is

$$\frac{j * 2 π}{N} ,$$

j is a positive integer less than or equal to N-1. The radius of the nanostructure is taken as a characteristic parameter as an example, and searching in the phase response φ(rᵢ₁, rᵢ₂, rᵢ₃, λᵢ) obtained by the interpolation, so as to select the combination of characteristic parameters (rᵢ₁ⱼ, rᵢ₂ⱼ, rᵢ₃ⱼ) of the structural units met the design requirements. M is taken to be the number of sampling points, and scanning the combination of characteristic parameters (r_{i1N}, r_{i2N}, r_{i3N}), then selecting the combination of characteristic parameters which could make the phase responses of the structural units for M wavelengths be closed to or satisfy the design requirements. The mathematical expression of the above process is as min

$$( {\sum }_{1}^{M} \vert φ 1 ( {r}_{i 1 j} , {r}_{i 2 j} , {r}_{i 3 j} , {λ}_{i} ) - \frac{j * 2 π}{N} ) \vert ) ,$$

where M is a number of the sampling wavelengths in the multi-wavelength sampling; N is a number of the target structural units; φ(rᵢ₁ⱼ, rᵢ₂ⱼ, rᵢ₃ⱼ, λᵢ) is a normalized phase of the jₜₕ structural unit at the iₜₕ wavelength; and j is a positive integer which is less than or equal to N-1. Finally, the method includes: performing a FDTD simulation on the structural units obtained by the above process, so as to obtain results of phase responses of the structural units for the broadband. And the results are used to identify the accuracy of the interpolation.

For example, the metalens working at the visible waveband (400 nm-700 nm) is taken as an example. For example, the shape of the nanostructures is cylinder with a periodicity of 220 nm, and variation range of the diameter of the cylinder is from 50 nm to 170 nm. The diameter of the nanostructure is taken as the characteristic parameter, and each 10 nm is the sampling interval of the characteristic parameter and each 30 nm is the sampling interval of the wavelength. The structural unit database is constructed based on the results of the phase responses obtained by scanning 13*13*13*13*11 structural units.

Next, the method includes obtaining a target structural unit by performing an interpolation search according to the function. Firstly, setting the radius of the search step of the nanostructure in each interpolated structural unit, e.g. 0.5 nm, 1 nm, 2 nm, or any value smaller than the sampling interval (10 nm) of the initial structural unit. The sampling array of the determined characteristic parameter search step is calculated by the pre-set periodicity(220 nm) and characteristic variation range of unit cells (50-170 nm), e.g., setting the radius search step of the characteristic parameter (e.g., the nanostructure radius) is 0.5 nm and the periodicity of the nanostructures is 220 nm, the changes of the diameter of the nanostructure is 50, 50.5, 60 . . . 169.5, 170 nm, and total is 241 sampling points. In the whole structural unit, each layer varies as shown above. It is not difficult to understand that you can search from the minimum value to the maximum value of the characteristic parameters, or from the maximum value to the minimum value of the characteristic parameters. In addition, based on the interpolation of characteristic parameters, the number of wavelengths may be kept unchanged, or the wavelength sampling interval based on the interpolation may be set more finely than the wavelength sampling interval of the initial structural unit database when constructed. Taking 11 sampling wavelengths as an example, the phase φ(r₁, r₂, r₃, λ) was scanned when the initial structural unit database was established, and the data size was 13*13*13*11 by using the interpn function. The phase φ(r₁, r₂, r₃, λ) may be considered as a high-dimensional function, whose independent variables includes r₁, r₂, r₃ and λ. Theoretically, for each group of independent variables in the specified range is a uniquely determined correspondence, that is, a process of continuous change. Based on the discrete phase data obtained in the initial structural unit database, the database may be enriched by obtaining the values of phase function corresponding to the unsampled independent variables through the supplementary data. In this way, a more elaborate structural unit database can be obtained than the initial structural unit database. A more detailed search can be done based on this method.

If the initial structural unit database is constructed with the characteristic parameter of 1 nm, 121*121*121*11 results need to be scanned, and the corresponding scanning time will increase to 121*121*121/13/13/13*7/24≈276 days. According to the embodiment of the present application, the required calculation time does not exceed 8 hours by firstly taking 10 nm as the characteristic parameter of the scanning intervals, then interpolating.

Therefore, the method of designing the metalens provided by the embodiment of the present application optimizes the design strategy of the metalens, greatly saves the number of computational instances, and significantly improves the computational efficiency. It should be understood that the initial structural unit database or the target structural unit database of the present application includes the structural information of the nanostructure, the phase information of the nanostructure, and the phase information of the structural unit composed of the nanostructure.

The characteristic parameter comprises one or more of a shape, radius, height, aspect ratio and refractive index of the nanostructure.

According to the embodiment of the present application, any one or more of the characteristic parameters of the nanostructure can be scanned as variables to obtain the phase response of the different structural units. For example, for cylindrical nanostructures, the characteristic parameters for scanning may be the radius of the nanostructure. For example, for rectangular nanostructures, the characteristic parameters for scanning may be the radius of the nanostructure. For example, for non-cylindrical nanostructures, such as octagonal prism or hexagonal prism, the characteristic parameters for scanning may be the radius or diameter of the outer circle of the cross-section of the nanostructure.

According to the embodiment of the present application, as shown in FIG. 7, the nanostructure 121 is also filled with a filler material 122, the refractive index of the filler material 122 is different from the refractive index of the nanostructure 121. Optionally, the nanostructure 121 may be a positive nanostructure or a negative nanostructure.

According to the embodiment of the present application, each phase-modulation layer is independent of each other, but the characteristic parameters of the nanostructure in each phase-modulation layer affect the phase response of the entire structural unit, so the characteristic parameters of each nanostructure in any structural unit may be any value within the allowable range of the process.

### EMBODIMENT 1

Embodiment 1 provides a metalens obtained by the method of designing a metalens of the present application. The working waveband of this metalens is from 400 nm to 700 nm. As shown in FIG. 7, the structural unit 1 includes a first phase-modulation layer, a second phase-modulation layer and a third phase-modulation layer successively along the direction near the substrate 11; the first phase-modulation layer includes a first nanostructure 1211 and a first filler material 1221; the second phase-modulation layer includes a second nanostructure 1212 and a second filler material 1222; and the third phase-modulation layer includes a third nanostructure 1213 and a third filler material 1223. Moreover, the interval between the first phase-modulation layer and the second phase-modulation layer is from 1 nm to 10 nm, and the interval between the second phase-modulation layer and the third phase-modulation layer is from 1 to 10 nm. The first nanostructure 1211 is made of silica, and the first filler material 1221 is silicon nitride; the height range of the first nanostructure 1211 is from 2.5 to 3.2 μm. The second nanostructure 1212 is made of silicon nitride, and the second filler material 1222 is silica; the height range of the second nanostructure 1212 is from 0.7 to 0.95 μm. The third nanostructure 1213 is made of a material with a refractive index between 1.6 and 2.0, preferably with a refractive index of 1.7; the third filler material 1223 is silica; and the third nanostructure 1213 has a height range from 0.7 to 0.95 μm. The first nanostructure 1211, second nanostructure 1212 and third nanostructure 1213 vary in a radius range from 25 to 85 nm. The range of the refractive index of the material of the third nanostructure 1213 is designed to be within the interval of [1.6, 2.0], so that the impedance matching of the third nanostructure 1213 with the substrate is smaller, thereby facilitating improving the transmittance.

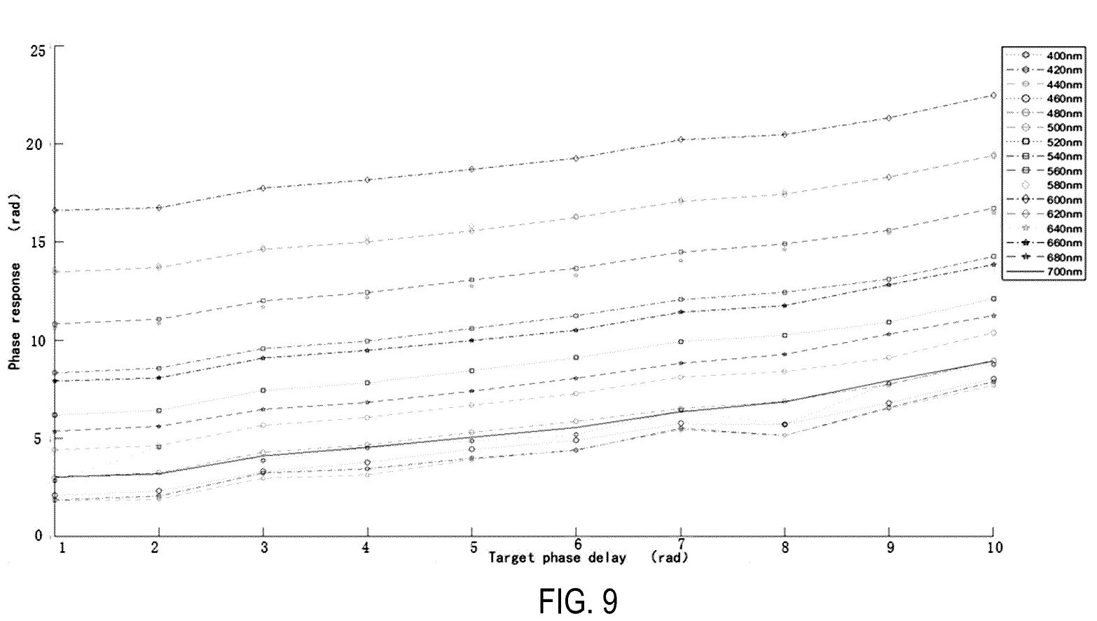

Embodiment 1 selects 11 structural units, and performs an interpolation search on the radius of the three nanostructures in each structural unit as variables, the search step is configured to be that the change of the radius of the nanostructure is less than mm, and the range of radius of the nanostructures after the search is shown in Table 1. The phase responses of the target structural units at different wavelengths (selecting 16 wavelengths with the interval of 20 nm in the range of broadband of [400 nm, 700 nm]) are shown in FIG. 9. The vertical ordinate in FIG. 9 is the phase response of the metalens with the unit of rad; in FIG. 9, the target phase delay has the unit of rad. Different fold lines represent the phase response of the metalens at different sampling wavelengths. FIG. 9 shows the phase response of metalenses corresponding to wavelengths of 400 nm, 420 nm, 440 nm, 460 nm, 480 nm, 500 nm, 520 nm, 540 nm, 560 nm, 580 nm, 600 nm, 620 nm, 640 nm, 660 nm, 680 nm and 700 nm, respectively. The fold lines corresponding to the same wavelength in FIG. 9 show the phase responses of the selected 11 structural units in Table 1 (corresponding to serial numbers from 1 to 11 in the left to the right). According to FIG. 9, the structural unit obtained by the interpolation search in Embodiment 1 can cover the phases of [0,2π] for different wavebands and have the same range of phase response for different wavelengths. Thus, Embodiment 1 satisfies design requirements of both large aperture and broadband imaging for the metalens.

| Numbered | Diameter of | Diameter of | Diameter of |
|---|---|---|---|
| of the | the first | the second | the third |
| nanostructures | nanostructure(nm) | nanostructure(nm) | nanostructure(nm) |
| 1 | 80-85 | 50-55 | 60-65 |
| 2 | 70-75 | 50-55 | 55-60 |
| 3 | 35-40 | 55-60 | 50-55 |
| 4 | 25-30 | 55-60 | 40-50 |
| 5 | 40-45 | 45-50 | 40-45 |
| 6 | 25-30 | 45-50 | 35-40 |
| 7 | 25-30 | 45-50 | 25-30 |
| 8 | 30-35 | 45-50 | 25-30 |
| 9 | 55-60 | 65-70 | 65-70 |
| 10 | 60-65 | 70-75 | 65-70 |
| 11 | 80-85 | 55-60 | 60-65 |

### Embodiment 2

Embodiment 2 provides a metalens obtained by the method of designing a metalens of the present application. The working waveband of this metalens is from 400 nm to 700 nm. As shown in FIG. 7, the structural unit 1 includes a first phase-modulation layer, a second phase-modulation layer and a third phase-modulation layer successively along the direction near the substrate 11; the first phase-modulation layer includes a first nanostructure 1211 and a first filler material 1221; the second phase-modulation layer includes a second nanostructure 1212 and a second filler material 1222; and the third phase-modulation layer includes a third nanostructure 1213 and a third filler material 1223. Moreover, the interval between the first phase-modulation layer and the second phase-modulation layer is from 1 nm to 10 nm, and the interval between the second phase-modulation layer and the third phase-modulation layer is from 1 to 10 nm. The first nanostructure 1211 is made of silica, and the first filler material 1221 is silicon nitride; the height range of the first nanostructure 1211 is from 2.5 to 3.2 μm. The second nanostructure 1212 is made of silicon nitride, and the second filler material 1222 is silica; the height range of the second nanostructure 1212 is from 0.7 to 0.95 μm. The third nanostructure 1213 is made of a material with a refractive index between 1.6 and 2.0, preferably with a refractive index of 1.7; the third filler material 1223 is silica; and the third nanostructure 1213 has a height range from 0.7 to 0.95 μm. The first nanostructure 1211, second nanostructure 1212 and third nanostructure 1213 vary in a radius range from 25 to 85 nm.

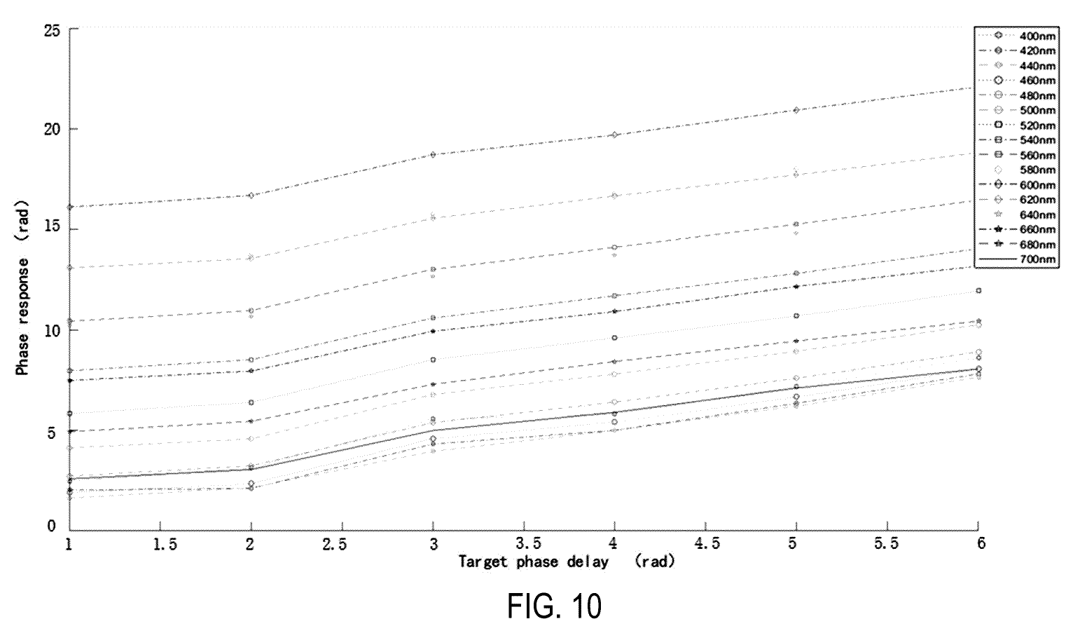

Embodiment 2 selects 6 structural units, and performs an interpolation search on the radius of the three nanostructures in each structural unit as variables, the search step is configured to be that the change of the radius of the nanostructure is less than mm, and the range of radius of the nanostructures after the search is shown in Table 2. The phase responses of the target structural units at different wavelengths (selecting 16 wavelengths with the interval of 20 nm in the range of broadband of [400 nm, 700 nm]) are shown in FIG. 10. The vertical ordinate in FIG. 10 is the phase response of the metalens with the unit of rad; in FIG. 10, the target phase delay has the unit of rad. Different fold lines represent the phase response of the metalens at different sampling wavelengths. FIG. 10 shows the phase response of metalenses corresponding to wavelengths of 400 nm, 420 nm, 440 nm, 460 nm, 480 nm, 500 nm, 520 nm, 540 nm, 560 nm, 580 nm, 600 nm, 620 nm, 640 nm, 660 nm, 680 nm and 700 nm, respectively. The fold lines corresponding to the same wavelength in FIG. 10 show the phase responses of the selected 6 structural units in Table 2 (corresponding to serial numbers from 1 to 6 in the left to the right). According to FIG. 10, the structural unit obtained by the interpolation search in Embodiment 1 can cover the phases of [0,2π] for different wavebands and have the same range of phase response for different wavelengths. Thus, Embodiment 2 satisfies design requirements of both large aperture and broadband imaging for the metalens.

TABLE 2

| Numbered | Diameter of | Diameter of | Diameter of |
|---|---|---|---|
| of the | the first | the second | the third |
| nanostructures | nanostructure(nm) | nanostructure(nm) | nanostructure(nm) |
| 1 | 60-65 | 75-80 | 65-70 |
| 2 | 35-40 | 70-75 | 60-65 |
| 3 | 30-35 | 60-65 | 45-50 |
| 4 | 55-60 | 45-50 | 35-40 |
| 5 | 30-35 | 45-50 | 25-30 |
| 6 | 80-85 | 40-45 | 25-30 |

It should be noted that the metalens provided by the embodiment of the present application can be processed through a semiconductor fabrication, and has the advantages of light weight, thin thickness, simple structure and process, low cost and high consistency in mass production.

In conclusion, the method of designing the metalens provided in the present application embodiment determines the phase response of each phase-modulation layer of the first number of phase-modulation layers by taking at least one characteristic parameter of the nanostructures of the first number structural units in the first phase-modulation layer; the phase response is a function between the incident wavelength and at least one characteristic parameter; and an interpolation search is performed based on the function, so that the target structural unit is obtained. And the target structural unit has the same phase response to different wavelengths in the broadband. In this way, the broadband limitation to the aperture of metalens is broken, and large aperture and broadband imaging of metalens is realized.

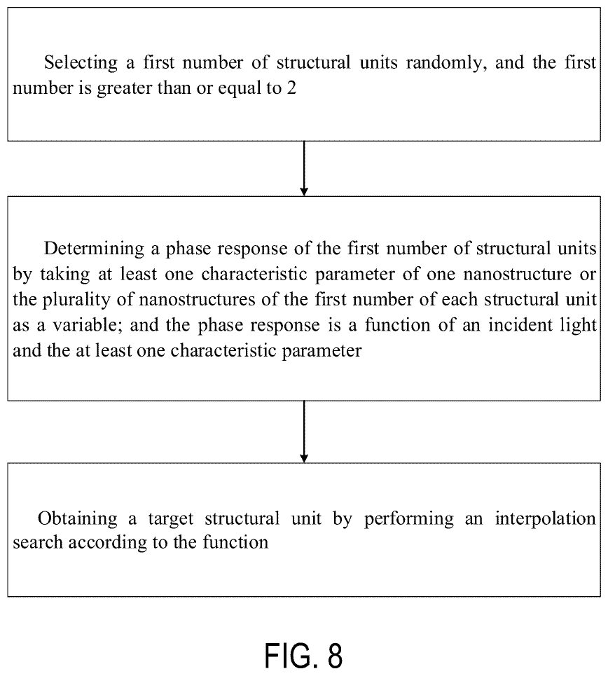

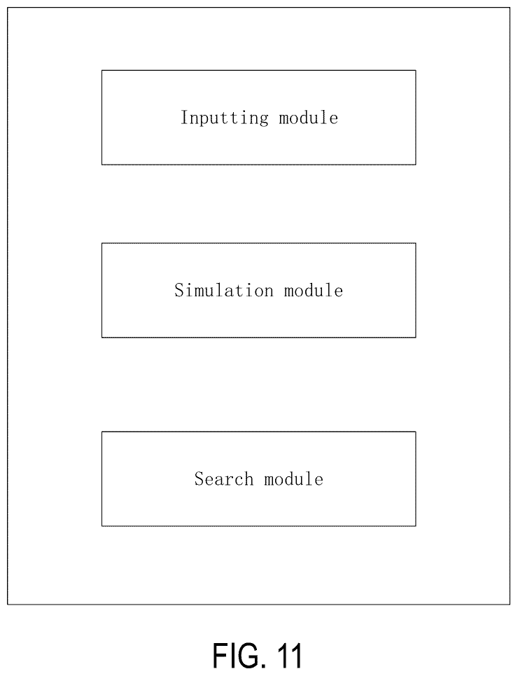

From FIG. 1 to FIG. 10, the method of designing the metalens provided in the present application embodiment is described in detail, which can also be realized by a corresponding device. The design device of the metalens provided in the embodiment of the present application will be described in detail in combination with FIG. 11.

FIG. 11 shows a schematic configuration of a design device for a metalens provided by the embodiment of the present application. As shown in FIG. 11, the design device of the metalens includes:
an inputting module, the inputting module is configured to input a number of structural units, a number of phase-modulation layers and characteristics parameters of each nanostructure in each structural unit;
a simulation module, the simulation module is configured to calculate a plurality of phase responses; and the phase responses is a function of the incident light and at least one characteristic parameter;
a search module, the search module is configured to perform an interpolation search according to the function.

In addition, an electronic device is provided, includes: a bus, a transceiver, a memory, a processor and a computer program; where the computer program is stored in the memory and executable on the processor; the transceiver, the memory and the processor are connected through the bus; the computer program is executed by the processor, so as to implement the method above.

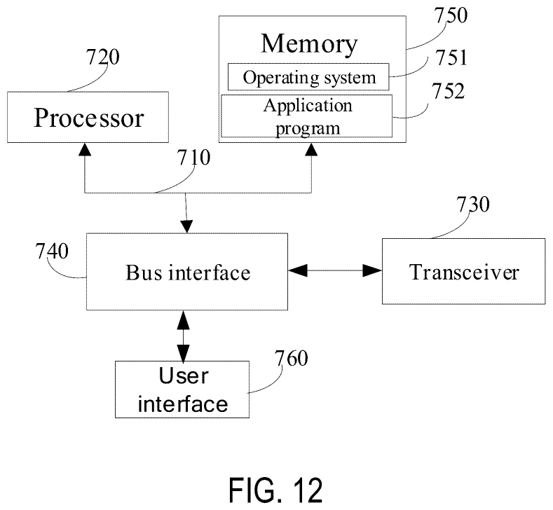

In one embodiment, referring to FIG. 12, the embodiment of this application also provides an electronic device including a bus 710, a processor 720, a transceiver 730, a bus interface 740, a memory 750, and a user interface 760.

In the embodiment of the present disclosure, the electronic device also includes a computer program stored on the memory 750 and the computer program can be operated on the processor 720. The computer program implements the steps of the above method of designing a metalens when the computer program is executed by the processor 720, and can achieve the same technical effect, in order to avoid repetition, it will not be repeated here.

In addition, a non-transitory computer-readable storage medium in which a computer program is stored, where the computer program is executed by a processor, so as to implement the steps of the method of designing an optical system. And the non-transitory computer-readable storage medium can achieve the same technical effect, in order to avoid repetition, it will not be repeated here.

The above is only a specific embodiment of the embodiments of this application, but the scope of protection of the embodiment of this application is not limited to this. And those skilled in the field can easily think of any change or substitution for this application, which should be covered within the protection scope of this application. Therefore, the scope of the protection of the present application shall be the scope of the claims.

What is claimed is:

1. A metalens, wherein the metalens comprises a substrate, a plurality of structural units arranged in periodicity; and the structural units are perpendicular to the substrate;
the metalens comprises a plurality of phase-modulation regions, and each phase-modulation region comprises the plurality of structural units;
wherein, each structural unit comprises m phase-modulation layers, m≥2, so as to make each structural unit in each phase-modulation region provide any phase within the interval of [0,2π] and each phase-modulation region cover the phases within the interval of [0,2π] at a working waveband.

2. The metalens according to claim 1, wherein the metalens comprises:
each phase-modulation layer in m phase-modulation layers comprises a nanostructure and a filler material;
the filler material is set around the plurality of nanostructures, and the height of the filler material is greater than or equal to the height of the plurality of nanostructures;
wherein all the phase-modulation layers of the structural units at the same level form a plate structure, and the plate structure is parallel to the substrate.

3. The metalens according to claim 2, wherein the phase-modulation layers comprise a first phase-modulation layer to an mₜₕ phase-modulation layer;
the first phase-modulation layer to the mₜₕ phase-modulation layer are stacked in the order from the substrate to the side away from the substrate;
the refractive index n of the filler material in the second phase-modulation layer to the mₜₕ phase-modulation layer satisfies: n≠1.

4. The metalens according to claim 1, wherein m=2.

5. The metalens according to claim 1, wherein m=3.

6. The metalens according to claim 2, wherein the metalens satisfies:
$$1 \leq \frac{{h}_{1}}{{h}_{2}} \leq 1.3 .$$
h₁ is the height of the filler material, and h₂ is the height of the plurality of nanostructures.

7. The metalens according to claim 3, wherein the metalens satisfies:
$$1 \leq \frac{{h}_{1}}{{h}_{2}} \leq 1.3$$
h₁ is the height of the filler material, and h₂ is the height of the plurality of nanostructures.

8. The metalens according to claim 6, wherein the metalens satisfies:
$$1 \leq \frac{{h}_{1}}{{h}_{2}} \leq 1.1$$
h₁ is the height of the filler material, and h₂ is the height of the plurality of nanostructures.

9. The metalens according to claim 7, wherein the metalens satisfies:
$$1 \leq \frac{{h}_{1}}{{h}_{2}} \leq 1.1$$
h₁ is the height of the filler material, and h₂ is the height of the plurality of nanostructures.

10. The metalens according to claim 1, wherein the metalens further comprises: a disconnected layer, and the disconnected layer is set between the adjacent phase-modulation layers.

11. The metalens according to claim 10, wherein the material of the disconnected layer is different from the material of the adjacent phase-modulation layer under the disconnected layer.

12. The metalens according to claim 1, wherein the shape of the phase-modulation region is a combination of at least two shapes of circle, square, rectangle, cross, glyph.

13. A method of designing a metalens, the method is applied to the metalens claimed as claim 1, wherein the method comprises:
selecting a first number of structural units randomly, and the first number is greater than or equal to 2;
determining a phase response of the first number of structural units by taking at least one characteristic parameter of one nanostructure or the plurality of nanostructures of the first number of each structural unit as a variable; and the phase response is a function of an incident light and the at least one characteristic parameter;
obtaining a target structural unit by performing an interpolation search according to the function.

14. The method according to claim 13, wherein “performing an interpolation search according to the function” comprises:
determining a second number of the structural units, so as to realize the phase of the metalens covering the phases from 0 to 2π;
performing a multi-wavelength sampling on each nanostructure of the second number of the structural units and selecting a combination of characteristic parameters corresponding to the minimum absolute value of the sum of phase variations between the phase responses and the target phases at the sampling wavelengths;
constructing the second number of target structural units based on the characteristic parameters corresponding to the minimum absolute value of the sum of phase variations between the phase responses and the target phases at the sampling wavelengths.

15. The method according to claim 13, wherein the phase of the target structural units satisfies:
$$min ( {\sum }_{1}^{M} \vert ( φ 1 ( {r}_{i 1 j} , {r}_{i 2 j} , {r}_{i 3 j} , {λ}_{i} ) - \frac{j * 2 π}{N} ) \vert ) ;$$
wherein, M is a number of the sampling wavelengths in the multi-wavelength sampling; N is a number of the target structural units; φ1(rᵢ₁ⱼ, rᵢ₂ⱼ, rᵢ₃ⱼ, λᵢ) is a normalized phase of the jₜₕ structural unit at the iₜₕ wavelength; and j is a positive integer which is less than or equal to N-1.

16. The method according to claim 13, wherein the characteristic parameter comprises one or more of a shape, radius, height, aspect ratio and refractive index of the nanostructure.

17. The method according to claim 13, wherein the multi-wavelength sampling comprises:
selecting a plurality of discrete wavelengths in a working waveband of the metalens;
at each wavelength of the plurality of discrete wavelengths, determining the phase response by taking a radius of one nanostructure or the plurality of nanostructures;
selecting the radius of the nanostructure that corresponding to the minimum absolute value of the sum of phase variations between the phase responses and the target phases at the plurality of discrete wavelengths.

18. A device of designing a metalens, the device is applied to implement the method claimed as claim 13, wherein the device comprises:
an inputting module, the inputting module is configured to input a number of structural units, a number of phase-modulation layers and characteristics parameters of each nanostructure in each structural unit;
a simulation module, the simulation module is configured to calculate a plurality of phase responses; and the phase responses is a function of the incident light and at least one characteristic parameter;
a search module, the search module is configured to perform an interpolation search according to the function.

19. An electronic device, comprising: a bus, a transceiver, a memory, a processor and a computer program;
wherein the computer program is stored in the memory and executable on the processor; the transceiver, the memory and the processor are connected through the bus; the computer program is executed by the processor, so as to implement the method of claim 13.

20. A non-transitory computer-readable storage medium in which a computer program is stored, wherein the computer program is executed by a processor, so as to implement the method of claim 13.
